(19) United States
(12) Patent Application Publication
(10) Pub. No.: US 2008/0166180 A1
(43) Pub. Date: Jul. 10, 2008

(54) Pivotal device

(75) Inventors: Jamie Horng, Shulin City (TW); Chun-Min Wang, Shulin City (TW)

Correspondence Address: JACKSON WALKER, L.L.P., 112 E. PECAN, SUITE 2400, SAN ANTONIO, TX, 78205, US

(73) Assignee: Shin Zu Shing Co., Ltd.

(21) Appl. No.: 11/650,779

(22) Filed: Jan. 8, 2007

(51) Int. Cl. F16C 11/04

(52) U.S. Cl. 403/118

(57) ABSTRACT

A pivotal device is mounted between a cap and a base of an electronic appliance, and has a resisting washer and an actuating washer rotated relative to each other. The resisting washer has an arcuate skewed surface formed in a side facing to the actuating washer and the actuating washer has lugs formed in a side and sliding along the skewed surface. With the coordination of the lugs and skewed surface, the cap has an enhancing friction when the cap is closing relative the base. Furthermore, the cap has a decreasing friction when the cap is opening relative to the base.

### BACKGROUND OF THE INVENTION

1. Field of the Invention

The present invention relates to a pivotal device with open lightly and close heavily, and more particularly to a pivotal device that is mounted between a cap and a base of a device and therefore, the cap can open or close relative to the base.

2. Description of the Related Art

A conventional pivotal device is mounted between a cap and a base of a device so that the cap can open or close relative to the base. When the cap is closed relative to the base, the user slows down the speed of the cap closure to prevent the cap from bumping the base. Also, when the cap is opened relative to the base, the user opens the cap with a quick speed to open the cap as quickly as possible. However, with the same friction between the components of the conventional pivotal device, the user should open or close the cap using extra force.

Therefore, the invention provides a pivotal device with open lightly and close heavily to mitigate or obviate the aforementioned problems.

### SUMMARY OF THE INVENTION

The main objective of the present invention is to provide a pivotal device with self friction to provide open lightly and close heavily to open or close the cap relative to the base without the extra force by the user.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pivotal device with open lightly and close heavily in accordance with the present invention;

FIG. 2 is an exploded perspective view of the pivotal device in FIG. 1;

FIG. 3 is another exploded perspective view of the pivotal device in FIG. 1;

FIG. 4 is an exploded perspective view of a resisting washer and an actuating washer of the pivotal device in FIG. 1;

FIG. 5 is an exploded perspective view of another embodiment of a resisting washer and an actuating washer of a pivotal device in accordance with the present invention;

FIG. 6 is a side view of the pivotal device in FIG. 1; and

FIG. 7 is a cross sectional side view of the pivotal device along line 7-7 in FIG. 6.

### DETAILED DESCRIPTION OF THE PREFERRED EMBODIMENT

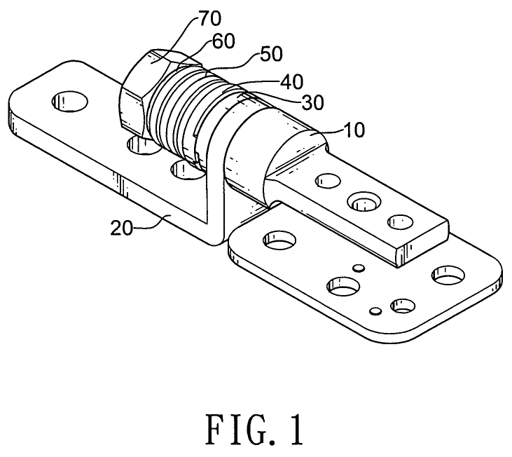

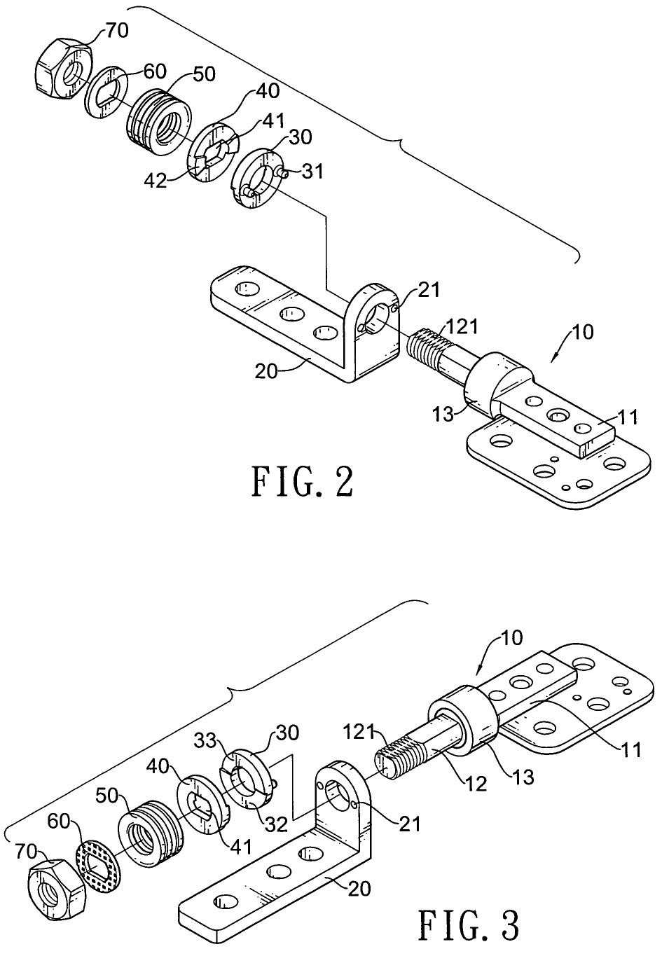

With reference to FIGS. 1 and 2, a pivotal device with open lightly and close heavily in accordance with the present invention has an axle (10), a bracket (20), a resisting washer (30, 30′), an actuating washer (40), an elastic unit (50), at least one friction washer (60) and a fastener (70).

The axle (10) has a fixing portion (11) formed in a first end of the axle (10) and a non-circular bar (12) formed in a second end of the axle (10). The bar (12) has a threaded portion (121) formed a free end of the bar (12). Ahead (13) is formed radially between the fixing portion (11) and the bar (12).

The bracket (20) is mounted around the bar (12) and has two fastening holes (21) defined through the bracket (20).

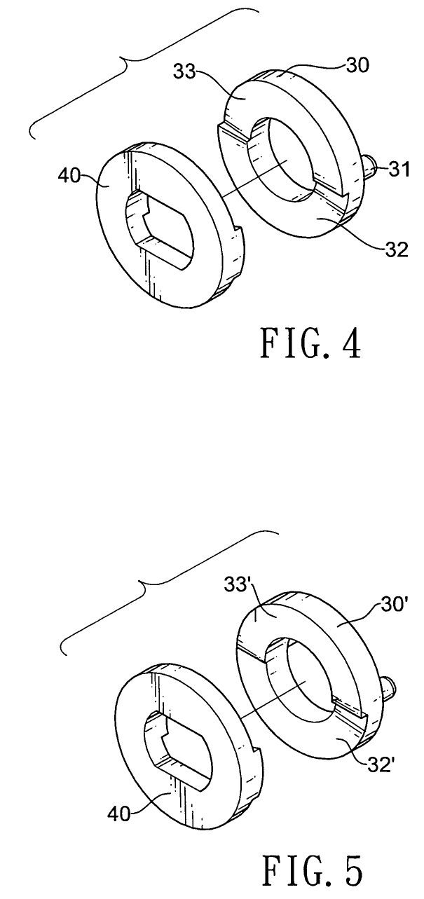

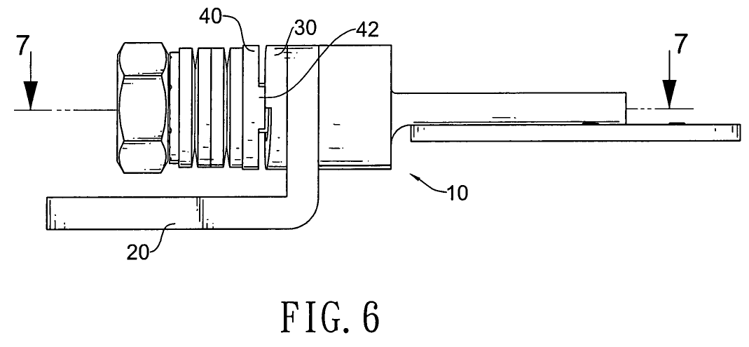

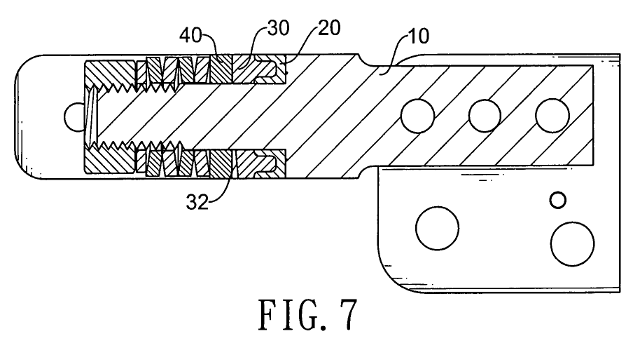

With further reference to FIGS. 3 to 5, the resisting washer (30, 30′) is mounted around the bar (12) and is attached securely to the bracket (20). The resisting washer (30, 30′) has a first side and a second side opposite to each other. The first side of the resisting washer (30, 30′) faces the bracket (20). The resisting washer (30) has two fastening protrusions (31) formed on the first side of the resisting washer (30), extending towards the bracket (20) and engaged with the fastening holes (21) in the bracket (20) to attach the resisting washer (30) securely to the bracket (20). The resisting washer (30) has an arcuate skewed surface (32) and a flat formed continually on the second side of the resisting washer (30). The skewed surface (32) may occupy a semicircle and the flat (33) may occupy a semicircle correspondingly. The skewed surface (32) has a first end and a second end. A thickness of the first end of the skewed surface (32) is thicker than a thickness of the second end of the skewed surface (32). A thickness of the skewed surface (32) is gradually thicker from the first end to the second end. The thickness of the first end of the skewed surface may be thicker or thinner than a thickness of the flat (33).

The actuating washer (40) is mounted securely on the bar (12) of the axle (10) and has a non-circular orifice (41) defined through a center of the actuating washer (40). The non-circular orifice (41) engages the non-circular bar (12) to mount the actuating washer (40) securely on the axle (10). The actuating washer (40) is adjacent to the second side of the resisting washer (30) and has two lugs (42) extending towards the resisting washer (30) and opposite to each other. When the actuating washer (40) is rotated relative to the resisting washer (30), one of the lugs (42) slides along the skewed surface (32).

The elastic unit (50) and the friction washer (60) are respectively mounted around the bar (12). The fastener (70) is mounted around and fixed to an end of the bar (12). The fastener (70) can be a nut to screw to the threaded portion (121) of the bar (12).

The present invention is mounted between a base and a cap of an electronic appliance. The fixing portion (11) is fixed to the cap and the bracket (20) is fixed to the base. When the cap is opened or closed relative to the base, the axle (10) is rotated relative to the bracket (20) and the axle (10) drives the actuating washer (40) to rotate relative to the resisting washer (30). Hence, the lugs (42) slide along the skewed surface (32).

When the cap is closed, the lugs (42) sliding from the second end to the first end of the skewed surface (32) so that the friction between the actuating washer (40) and the resisting washer (30) is enhanced. Therefore, the enhancing friction slows down the closing speed of the cap.

When the cap is opened, the lugs (42) sliding from the first end to the second end of the skewed surface (32) so that the friction between the actuating washer (40) and the resisting washer (30) is decreased. Therefore, the decreasing friction speeds up the opening speed of the cap.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. A pivotal device comprising:
an axle;
a bracket mounted around the axle;
a resisting washer mounted around the axle and attached securely to the bracket and having
a first side facing to the bracket;
a second side opposite to the first side; and
an arcuate skewed surface formed on the first side;
an actuating washer mounted securely on the axle, adjacent to the resisting washer and having two lugs extending towards the resisting washer and corresponding to the skewed surface of the resisting washer;
an elastic unit mounted around the axle;
a friction washer mounted the axle; and
a fastener mounted securely on an end of the axle.

2. The pivotal device as claimed in claim 1, wherein
the skewed surface of the resisting washer has
a first end having a thickness; and
a second end having a thickness and thinner than the first end wherein a thickness of the skewed surface is gradually thicker from the first end to the second end; and
the resisting washer has a flat formed on the first side of the resisting washer continually with the skewed surface and having a thickness.

3. The pivotal device as claimed in claim 2, wherein the thickness of the first end of the skewed surface is thinner than the thickness of the flat.

4. The pivotal device as claimed in claim 2, wherein the thickness of the second end of the skewed surface is thicker than the thickness of the flat.

5. The pivotal device as claimed in claim 1, wherein
the axle has
a fixing potion formed in a first end of the axle;
a non-circular bar formed in a second of the axle and
a head formed radially between the bar and fixing portion;
the bracket is mounted around the bar;
the resisting washer is mounted around the bar;
the elastic unit is mounted around the bar;
the friction washer is mounted around the bar;
the actuating washer is mounted securely on the bar; and
the fastener is mounted securely on an end of the bar.

6. The pivotal device as claimed in claim 5, wherein the actuating washer has a non-circular orifice defined through a center of the actuating washer and engaging the bar of the axle.

7. The pivotal device as claimed in claim 6, wherein
the bracket has two fastening holes defined through the bracket; and
the resisting washer has two fastening protrusions extending towards the bracket and engaging the fastening holes in the bracket.
